(19) United States
(12) Patent Application Publication
(10) Pub. No.: US 2026/0280177 A1
(43) Pub. Date: Sep. 17, 2026

(54) CONNECTOR DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinji NOZAKI, Mie (JP); Daisuke SAITO, Mie (JP)

(21) Appl. No.: 18/842,397

(22) PCT Filed: Feb. 9, 2023
(86) PCT No.: PCT/JP2023/004424

§ 371 Date: Aug. 29, 2024

(30) Foreign Application Priority Data
Mar. 2, 2022 (JP) 2022-031670

(51) Int. Cl. H01R 13/436; H01R 13/514; H01R 13/518

(52) U.S. Cl. CPC H01R 13/4364; H01R 13/514; H01R 13/518

(57) ABSTRACT

A connector device (1) includes a first connector (10) including a plurality of first terminal fittings (18) and a second connector (20) connectable to the first connector (10). The second connector (20) includes a holder (22), a plurality of sub-connectors (33, 34) mounted in the holder (22) and a plurality of second terminal fittings (45) mounted in the sub-connectors (33, 34). The plurality of sub-connectors (33, 34) mounted in the holder (22) are individually movable from an initial position to a connection position where the first terminal fittings (18) and the second terminal fittings (45) are connected.

### TECHNICAL FIELD

The present disclosure relates to a connector device.

### BACKGROUND

Patent Document 1 discloses a lever-type connector provided with a first connector including a cam pin and a lever member mounted on a second connector. If the lever member is rotated, the both connectors are connected by the sliding of the cam pin and a cam groove of the lever member.

### PRIOR ART DOCUMENT

### Patent Document

Patent Document 1: JP 2018-107010 A.

### SUMMARY OF THE INVENTION

### Problems to be Solved

Since a maximum rotation angle of the lever member is limited, there is a problem that an operation force necessary to rotate the lever member increases and workability is reduced as poles of the connector increase.

A connector device of the present disclosure was completed on the basis of the above problem and aims to improve workability.

### Means to Solve the Problem

The present disclosure is directed to a connector device with a first connector including a plurality of first terminal fittings, and a second connector connectable to the first connector, the second connector including a holder, a plurality of sub-connectors mounted in the holder and a plurality of second terminal fittings mounted in the sub-connectors, and the plurality of sub-connectors mounted in the holder being individually movable from an initial position to a connection position where the first terminal fittings and the second terminal fittings are connected.

### Effect of the Invention

According to the present disclosure, workability can be improved.

### BRIEF DESCRIPTION OF THE DRAWINGS

FIG. 1 is a perspective view showing an assembled state of a connector device of a first embodiment.

FIG. 2 is a perspective view showing a disassembled state of the connector device.

FIG. 3 is a perspective view showing a state where sub-connectors are mounted at an initial position in a holder.

FIG. 4 is a back view showing the state where the sub-connectors are mounted at the initial position in the holder.

FIG. 5 is a section along A-A of FIG. 4.

FIG. 6 is a section along B-B of FIG. 4.

FIG. 7 is a section along C-C of FIG. 4.

FIG. 8 is a section along D-D of FIG. 4.

FIG. 9 is a perspective view showing a state where a second connector having the sub-connectors held at the initial position is connected to a first connector.

FIG. 10 is a back view showing the state where the second connector having the sub-connectors held at the initial position is connected to the first connector.

FIG. 11 is a section along E-E of FIG. 10.

FIG. 12 is a section along F-F of FIG. 10.

FIG. 13 is a perspective view showing a state where some sub-connectors are moved from the initial position to a connection position from the state shown in FIG. 9.

FIG. 14 is a plan view in section showing a state where the first and second connectors are connected and the sub-connectors are moved to the connection position.

FIG. 15 is a side view in section showing a state where the first and second connectors are connected and the sub-connectors other than a locking sub-connector are moved to the connection position.

FIG. 16 is a side view in section showing a state where the first and second connectors are connected and all the sub-connectors are moved to the connection position.

FIG. 17 is a perspective view showing an assembled state of a connector device of a second embodiment.

FIG. 18 is a perspective view showing a disassembled state of the connector device.

FIG. 19 is a plan view in section showing a state where first and second connectors are connected and sub-connectors are moved to a connection position.

### DETAILED DESCRIPTION TO EXECUTE THE INVENTION

### Description of Embodiments of Present Disclosure

First, embodiments of the present disclosure are listed and described.

(1) The connector device of the present disclosure is provided with a first connector including a plurality of first terminal fittings, and a second connector connectable to the first connector, the second connector including a holder, a plurality of sub-connectors mounted in the holder and a plurality of second terminal fittings mounted in the sub-connectors, and the plurality of sub-connectors mounted in the holder being individually movable from an initial position to a connection position where the first terminal fittings and the second terminal fittings are connected. According to the configuration of the present disclosure, if the second connector is connected to the first connector and the sub-connectors are moved forward to the connection position with the plurality of sub-connectors held at the initial position in the holder, the second terminal fittings are connected to the first terminal fittings. Since a maximum value of friction resistance generated between the first and second terminal fittings can be reduced by pushing the plurality of sub-connectors to the connection position at different timings, workability is excellent.

(2) Preferably, the connection position is set at a position in front of the initial position, and a rear end of a connecting portion formed on a rear end of the sub-connector projects further rearward than a rear end of the holder with the sub-connector located at the initial position. According to this configuration, at which of the initial position and the connection position the sub-connector is located is easily confirmed and an operation of pushing the sub-connector at the initial position to the connection position is easy.

(3) Preferably, the first terminal fittings and the second terminal fittings are held in such a positional relationship as not to be in contact with each other with the holder fit in the first connector and the sub-connectors located at the initial position. According to this configuration, friction resistance is not generated between the first and second terminal fittings in the process of fitting the holder into the first connector.

(4) Preferably, the sub-connector is formed with a resilient locking piece for restricting a movement of the sub-connector from the initial position to the connection position in a state where the holder is not fit in the first connector yet, and the first connector is formed with releasing portions for releasing movement restrictions by the resilient locking pieces when the holder is fit into the first connector. According to this configuration, movement restrictions by the resilient locking pieces are released by the releasing portions if the holder is fit into the first connector. Since the movement restrictions of the resilient locking pieces need not be manually released, workability is good.

(5) Preferably, in (4), the releasing portion releases the movement restriction by resiliently deforming the resilient locking piece, and the first connector is formed with an accommodation recess, the resilient locking piece being accommodated into the accommodation recess to resiliently return when the sub-connector is moved to the connection position. According to this configuration, the resilient locking piece can be prevented from being left resiliently deformed.

(6) Preferably, the plurality of sub-connectors are mounted in a stacked state in the holder, and the sub-connector is formed with a stopper for locking the other sub-connector adjacent in a stacking direction from behind. According to this configuration, if the sub-connector formed with the stopper is retained with respect to the holder, the sub-connector adjacent to that sub-connector can also be retained.

(7) Preferably, the first terminal fitting includes a tab to be inserted into the second terminal fitting, the first connector includes a connection space for accommodating the tabs, the holder being fit into the connection space, the first connector is formed with guide portions projecting along the tabs, and the sub-connector is guided by sliding in contact with the guide portion in the process of moving the sub-connector from the initial position to the connection position. According to this configuration, since the sub-connector is guided by the guide portion in the process of pushing the sub-connector from the initial position to the connection position, the tab is connected to the second terminal fitting without interference.

(8) Preferably, the holder is formed with a lock arm configured to be resiliently deformed in the process of fitting the holder into the first connector and restrict separation of the holder by resiliently returning with the holder properly fit in the first connector, the plurality of sub-connectors include a locking sub-connector including a deflection restricting portion, and the deflection restricting portion is located to restrict resilient deformation of the lock arm with the holder fit in the first connector and the locking sub-connector pushed to the connection position. According to this configuration, the deflection restricting portion of the locking sub-connector restricts the resilient deformation of the lock arm, whereby the holder and the first connector can be reliably held in a connected state.

### DETAILS OF EMBODIMENTS OF PRESENT DISCLOSURE

### First Embodiment

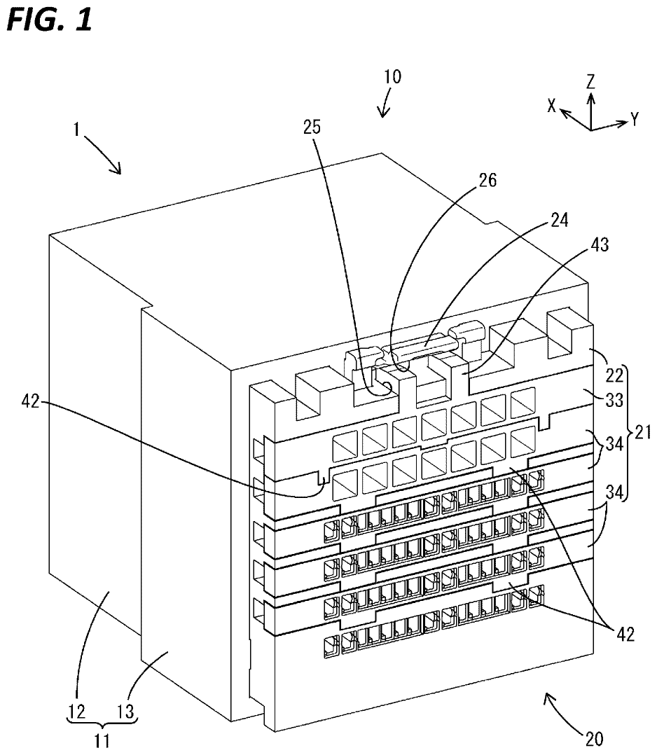

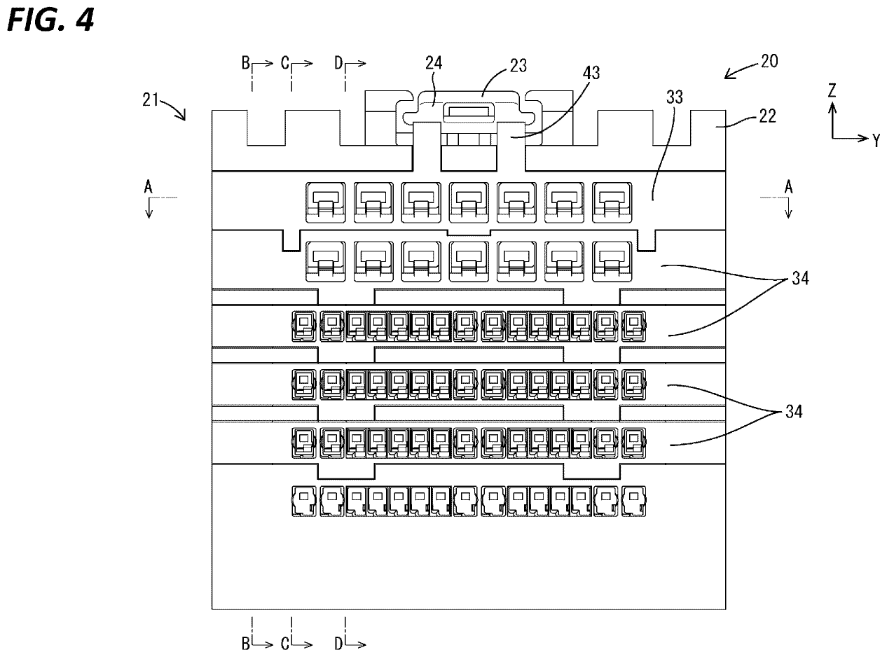

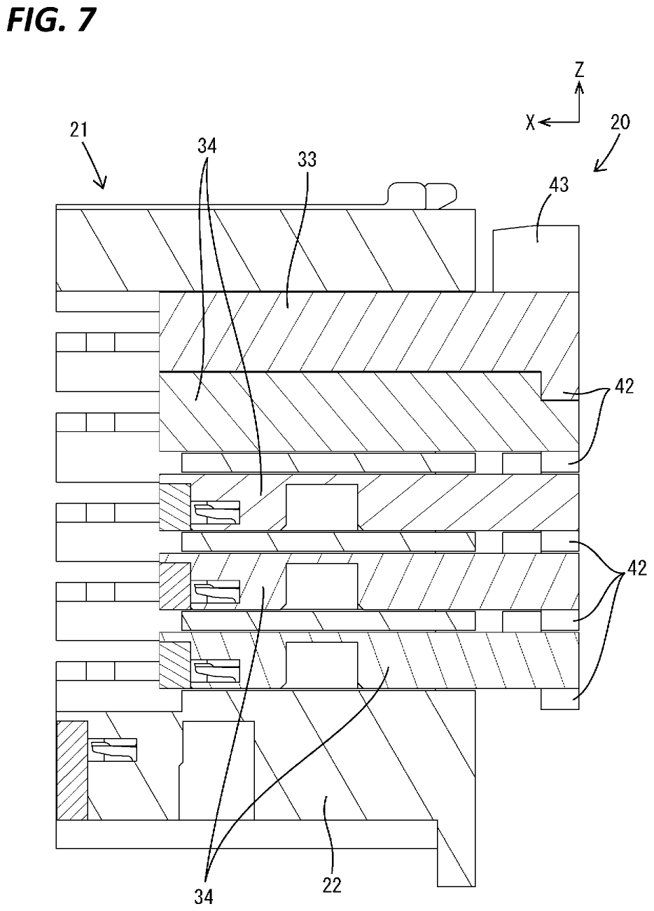

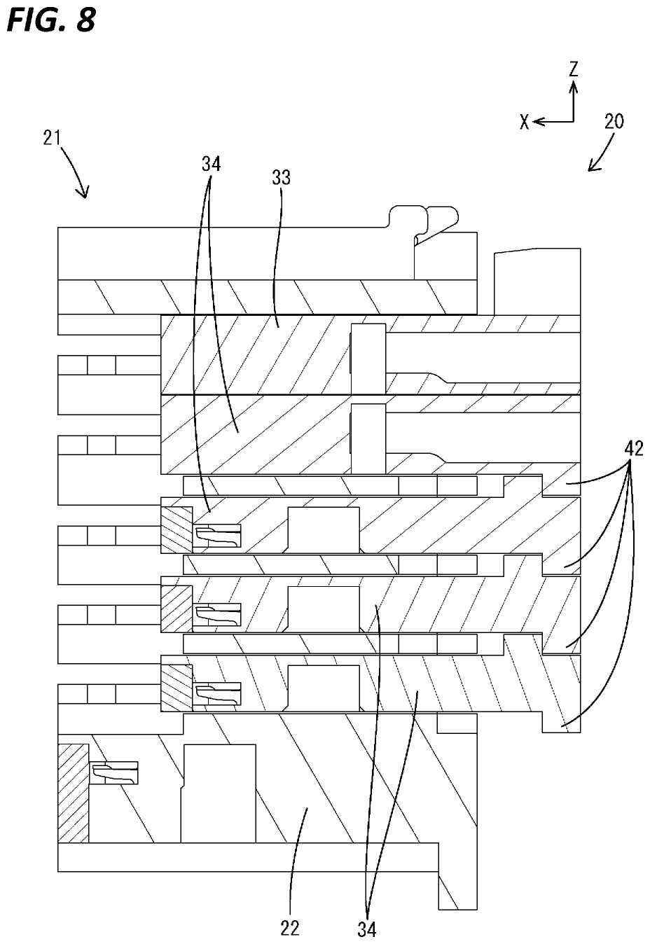

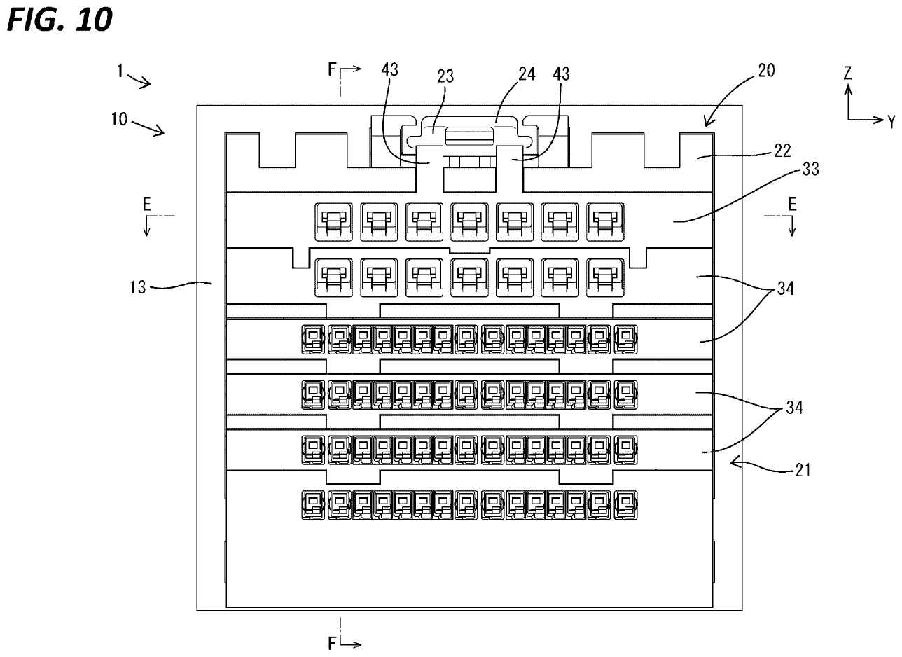

A connector device 1 of a first specific embodiment of the present disclosure is described below with reference to FIGS. 1 to 16. Note that the present invention is not limited to these illustrations, but is represented by claims and includes all changes in the scope of claims and in the meaning and scope of equivalents. In the first embodiment, a positive direction of an X axis in FIGS. 1 to 3, 5 to 9 and 11 to 16 is defined as a forward direction concerning a front-rear direction. A positive direction of a Y axis in FIGS. 1 to 5, 9 to 11, 13 and 14 is defined as a rightward direction concerning a lateral direction. A positive direction of a Z axis in FIGS. 1 to 4, 6 to 10, 12, 13, 15 and 16 is defined as an upward direction concerning a vertical direction.

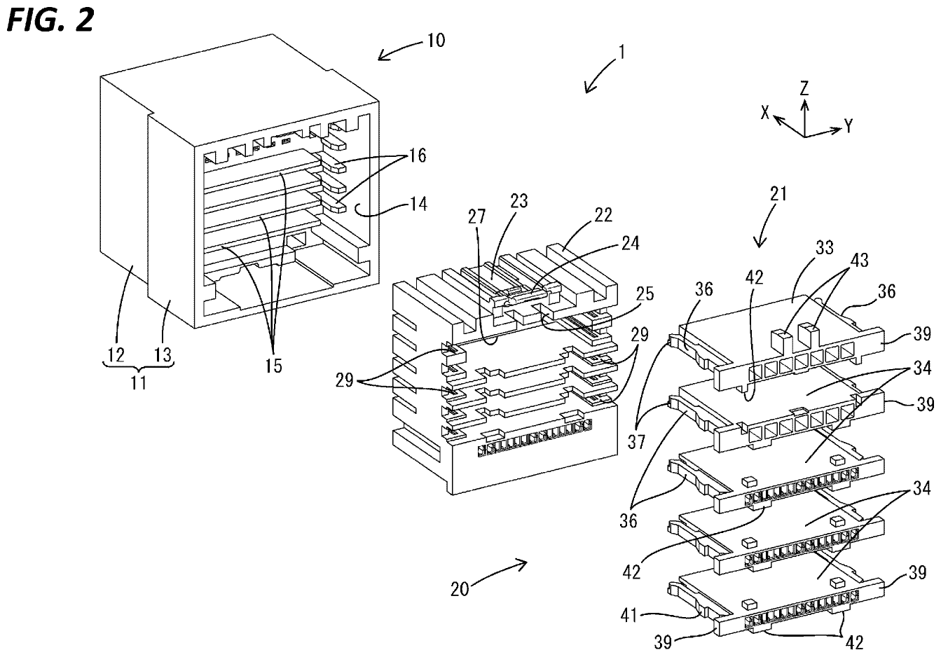

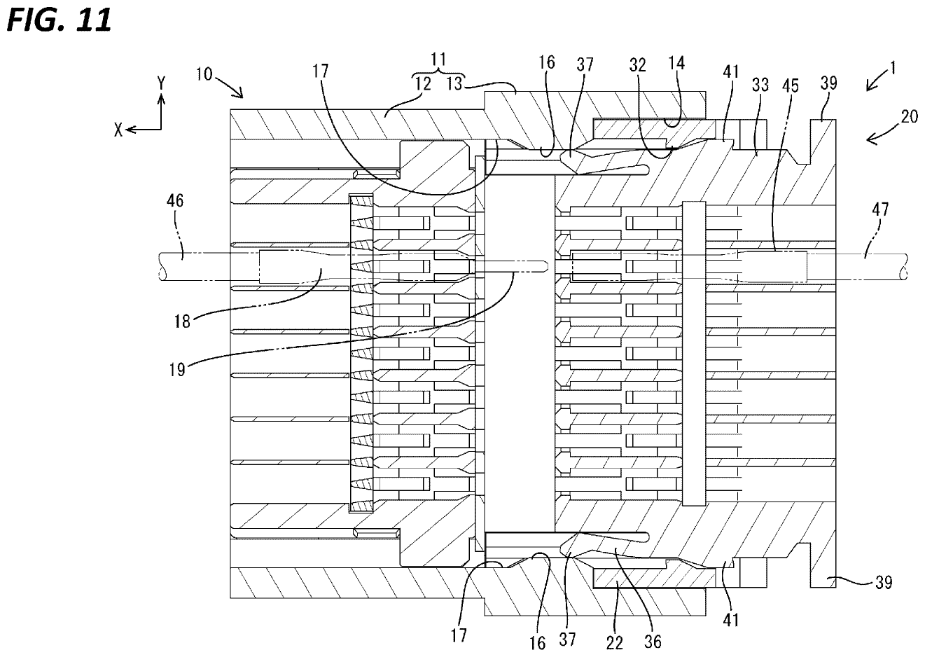

The connector device 1 of the first embodiment is, as shown in FIGS. 1 and 2, provided with a first connector 10 and a second connector 20. The first connector 10 is provided with a first housing 11 and a plurality of first terminal fittings 18. The first housing 11 is a single component including a terminal holding portion 12 and a receptacle 13 in the form of a rectangular tube projecting rearward (toward the first connector 10) from the outer peripheral edge of the terminal holding portion 12. The inside of the receptacle 13 is a connection space 14, into which a second housing 21 is fit. As shown in FIGS. 11, 12 and 14 to 16, the plurality of first terminal fittings 18 are mounted in the terminal holding portion 12. The first terminal fitting 18 is a male terminal connected to a first wire 46 and including a narrow tab 19 in a tip part. The first terminal fitting 18 is mounted in the first housing 11 with the tab 19 projecting into the receptacle 13 from the terminal holding portion 12.

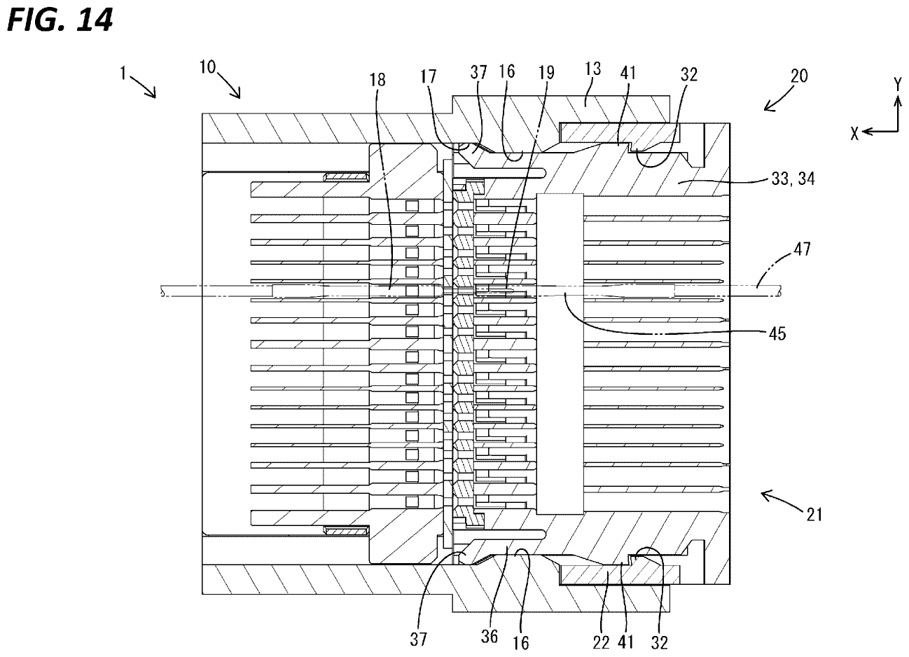

A lock portion (not shown) is formed on the lower surface of an upper wall portion of the receptacle 13. As shown in FIGS. 2, 12, 15 and 16, a plurality of guide portions 15 extending rearward from the terminal holding portion 12 are arranged in the receptacle 13. The plurality of guide portions 15 are in the form of flat plates having a plate thickness direction oriented in the vertical direction and arranged at intervals in the vertical direction. As shown in FIGS. 2, 11 and 14, a plurality of projection-like releasing portions 16 are formed at intervals in the vertical direction on both left and right inner side surfaces of the receptacle 13. The plurality of guide portions 15 and the plurality of releasing portions 16 are alternately arranged in the vertical direction. As shown in FIGS. 11 and 14, a plurality of accommodation recesses 17 are formed at intervals in the vertical direction in the both left and right inner side surfaces of the receptacle 13. The accommodation recess 17 is shaped to be recessed from the releasing portion 16. The accommodation recess 17 is located at the same height as the releasing portion 16 and arranged in front of and adjacent to the releasing portion 16.

The second connector 20 is provided with the second housing 21 and a plurality of second terminal fittings 45. The second housing 21 is provided with a holder 22 and a plurality of sub-connectors 33, 34 to be mounted into the holder 22 to be stacked in the vertical direction. The holder 22 is a single component made of synthetic resin. The holder 22 includes an upper wall portion, both left and right side wall portions and a lower wall portion and has a rectangular tube shape open in both front and rear surfaces.

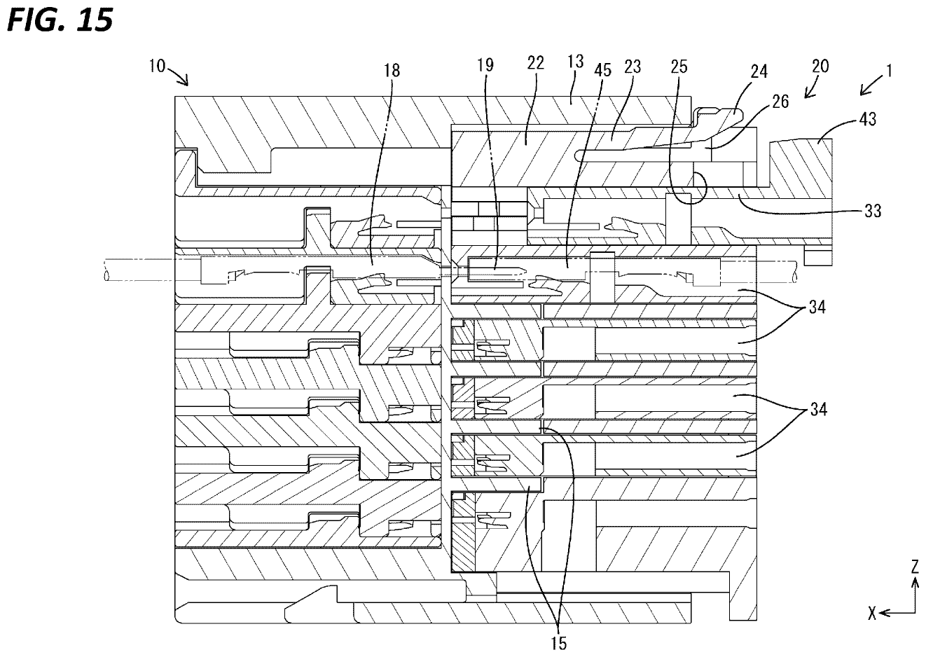

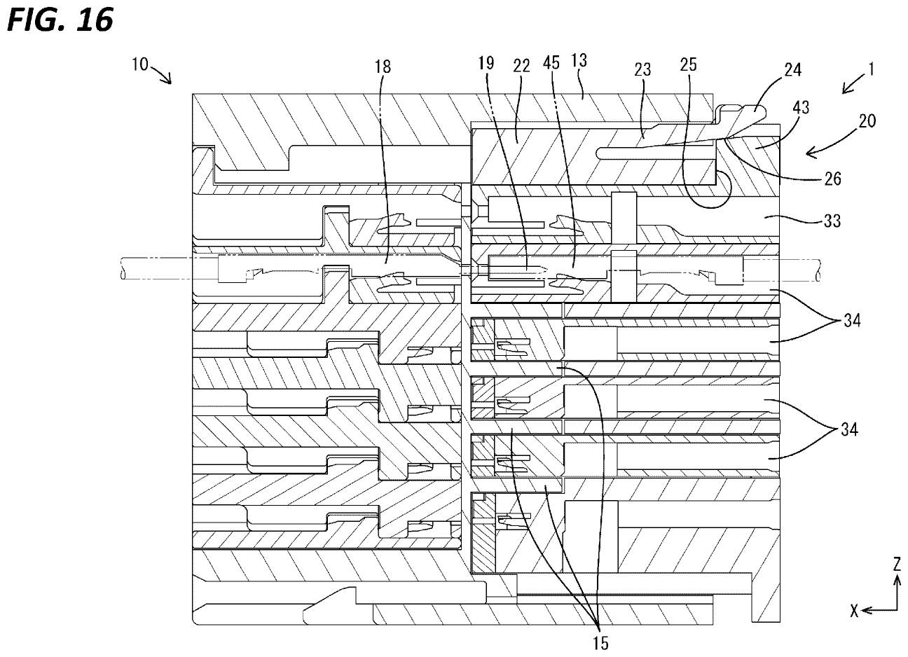

A lock arm 23 cantilevered rearward along the upper wall portion is formed on the upper surface of the holder 22. A release operating portion 24 is formed on a rear end part of the lock arm 23. The lock arm 23 is resiliently deformable in the vertical direction to bring the release operating portion 24 toward and away from the upper wall portion. A pair of left and right cut portions 25 are formed at positions of the upper wall portion right below the release operating portion 24. A space between the upper wall portion of the holder 22 and the release operating portion 24 is a deflection allowing space 26 (see FIGS. 15 and 16) for enabling the lock arm 23 to be resiliently deformed in an unlocking direction. The inside of the holder 22 serves as an accommodation space 27 for accommodating the plurality of sub-connectors 33, 34 stacked and arranged in the vertical direction.

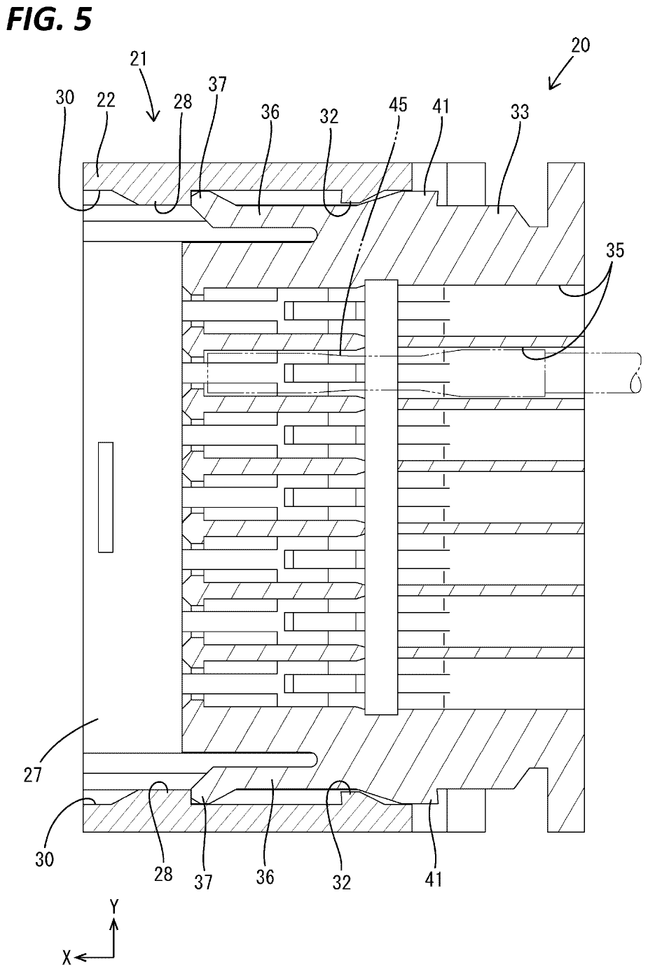

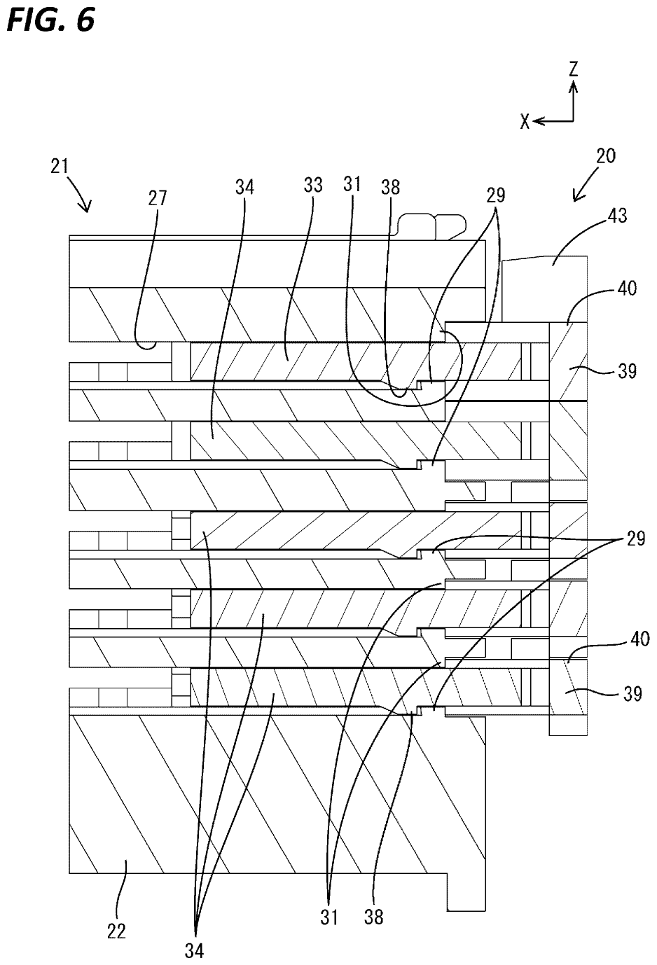

As shown in FIG. 5, a plurality of projection-like initial position front stop portions 28 are formed at intervals in the vertical direction on both left and right inner wall portions. As shown in FIGS. 2 and 6, a plurality of initial position retaining portions 29 are formed at intervals in the vertical direction on the both left and right inner wall portions. The initial position retaining portion 29 is arranged behind the initial position front stop portion 28. As shown in FIG. 5, a plurality of interference avoiding portions 30 are formed at intervals in the vertical direction on the both left and right inner wall portions. The interference avoiding portion 30 is shaped to be recessed from the initial position front stop portion 28. The interference avoiding portion 30 is located at the same height as the initial position front stop portion 28 and arranged in front of and adjacent to the initial position front stop portion 28.

As shown in FIG. 6, a plurality of projection-like connection position front stop portions 31 are formed at intervals in the vertical direction on the both left and right inner wall portions. The connection position front stop portion 31 is arranged in a rear end part of the accommodation space 27. As shown in FIGS. 5, 11 and 14, a plurality of connection position retaining portions 32 are formed at intervals in the vertical direction on the both left and right inner wall portions. The connection position retaining portion 32 is located at the same height as the initial position front stop portion 28 and arranged in front of and adjacent to the initial position front stop portion 28.

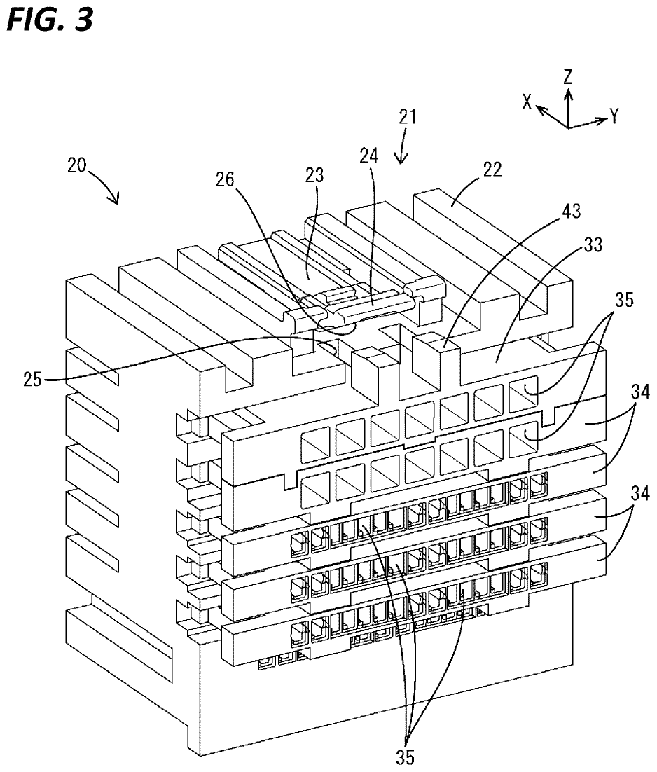

As shown in FIG. 2, the sub-connector 33, 34 is in the form of a flat thick plate having a vertical thickness smaller than dimensions in the front-rear direction and lateral direction. As shown in FIGS. 3, 5 and 12, a plurality of terminal accommodation chambers 35 arranged in the lateral direction are formed in each sub-connector 33, 34. The sub-connector 33, 34 is formed with a pair of left and right resilient locking pieces 36. The pair of resilient locking pieces 36 have a cantilever shape extending forward along both left and right outer side surfaces of the sub-connector 33, 34. An initial position butting portion 37 is formed on a front end part of the resilient locking piece 36.

As shown in FIG. 6, the sub-connector 33, 34 is formed with a pair of initial position locking projections 38. As shown in FIG. 2, a pair of left and right projection-like moving portions 39 are formed on a rear end part of the sub-connector 33, 34. As shown in FIG. 6, parts of the pair of moving portions 39 function as connection position butting portions 40. As shown in FIGS. 2, 5, 11 and 14, a pair of connection position locking projections 41 are formed on both left and right outer side surfaces of the sub-connector 33, 34. The connection position locking projection 41 is arranged behind the resilient locking piece 36. As shown in FIGS. 1, 2, 7 and 8, a pair of left and right stoppers 42 projecting downward are formed on a rear end part of each sub-connector 33, 34.

Out of the plurality of sub-connectors 33, 34, the sub-connector 33 arranged in the uppermost stage in a stacking direction functions as a locking sub-connector 33. The locking sub-connector 33 is formed with a pair of left and right deflection restricting portions 43. The deflection restricting portion 43 is shaped to project upward from a rear end part of the locking sub-connector 33.

As shown in FIGS. 5, 11, 12 and 14 to 16, the plurality of female second terminal fittings 45 connected to second wires 47 are inserted into the respective terminal accommodation chambers 35 from behind the sub-connector 33, 34. The second terminal fitting 45 is provided with a resilient contact piece (not shown) to be brought into contact with the tab 19 of the first terminal fitting 18 by being resiliently deformed.

Next, a connection process of the connector device 1 of the first embodiment is described. First, the second terminal fittings 45 are inserted into the terminal accommodation chambers 35 of each sub-connector 33, 34. Subsequently, as shown in FIG. 3, each sub-connector 33, 34 is inserted into the holder 22 from behind. At this time, the sub-connector 34 in the lowermost stage is first mounted and the sub-connectors 34 in upper stages are successively mounted. Finally, the locking sub-connector 33 in the uppermost stage is mounted. In the process of mounting each sub-connector 33, 34 into the holder 22, the initial position butting portions 37 ride over the connection position retaining portions 32 while the resilient locking pieces 36 are resiliently deformed inward in the lateral direction. Then, the initial position butting portions 37 are locked to the initial position front stop portions 28 from behind and the initial position locking projections 38 are locked to the initial position retaining portions 29 from front, whereby the sub-connector 33, 34 is held at the initial position.

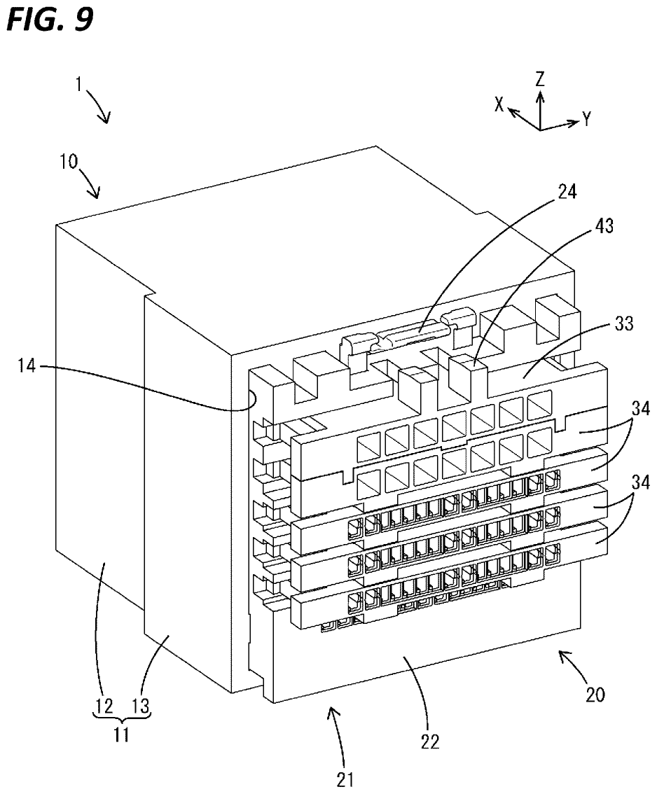

After all the sub-connectors 33, 34 are mounted at the initial position, the first and second housings 11, 21 are connected by inserting the holder 22 into the connection space 14 of the receptacle 13 as shown in FIG. 9. In the process of connecting the both housings 11, 21, the lock arm 23 is temporarily resiliently deformed downward. At this time, since the deflection restricting portions 43 of the locking sub-connector 33 are located behind the rear end of the lock arm 23, the resilient deformation of the lock arm 23 is not hindered. If the both housings 11, 21 are properly connected, the lock arm 23 resiliently returns and is locked to the lock portion (not shown). By this locking, the first housing 11 and the holder 22 are locked in the connected state.

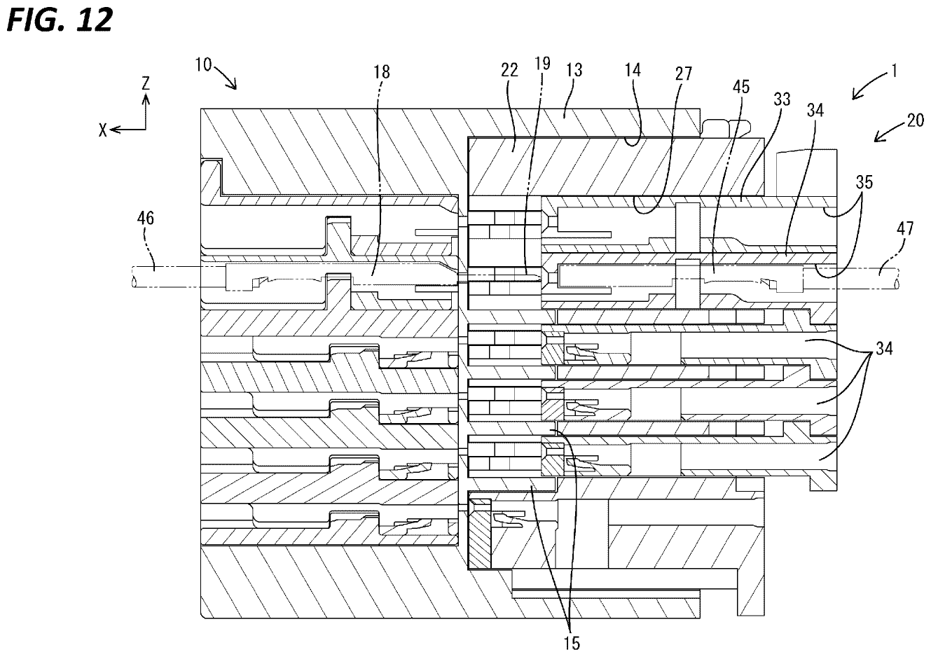

With the both housings 11, 21 properly connected and the sub-connectors 33, 34 located at the initial position, the front ends of the holder 22 and the sub-connectors 33, 34 have not reached the tabs 19 of the first terminal fittings 18 as shown in FIGS. 11 and 12, wherefore the first and second terminal fittings 18, 45 are not in contact. Further, as shown in FIG. 11, the resilient locking pieces 36 are resiliently deformed by the releasing portions 16 of the first housing 11, whereby the initial position butting portions 37 are disengaged from the initial position front stop portions 28. In this way, the sub-connectors 33, 34 held at the initial position can move forward to the connection position in front of the initial position.

After the both housings 11, 21 are properly connected, the sub-connectors 33, 34 are moved forward individually one by one from the initial position to the connection position. Here, with the sub-connectors 33, 34 held at the initial position, the moving portions 39 project rearward of the holder 22 and the rear ends of the moving portions 39 are located behind the rear end of the holder 22. The stoppers 42 of the respective sub-connectors 33, 34 other than the sub-connector 34 in the lowermost stage are arranged to face the sub-connectors 34 located in the lower stages thereof from behind. Therefore, if an attempt is made to move the locking sub-connector 33 in the uppermost stage forward, the sub-connectors 34 other than that in the uppermost stage are also moved forward together.

Thus, the sub-connector 34 in the lowermost stage is first pushed to the connection position. At this time, the moving portions 39 are pushed from behind. In the process of moving the sub-connector 34 forward to the connection position, the tabs 19 are inserted into the terminal accommodation chambers 35 and contact the resilient contact pieces (not shown) of the second terminal fittings 45, the contact of the tabs 19 and the second terminal fittings 45 starts, and friction resistance due to resilient forces of the resilient contact pieces is generated between the tabs 19 and the resilient contact pieces (not shown) until connection is completed. If the sub-connector 34 reaches the connection position, the connection position butting portions 40 are locked to the connection position front stop portions 31 from behind and, as shown in FIG. 14, the connection position locking projections 41 are locked to the connection position retaining portions 32 from front. By this locking, the sub-connector 34 is held at the connection position.

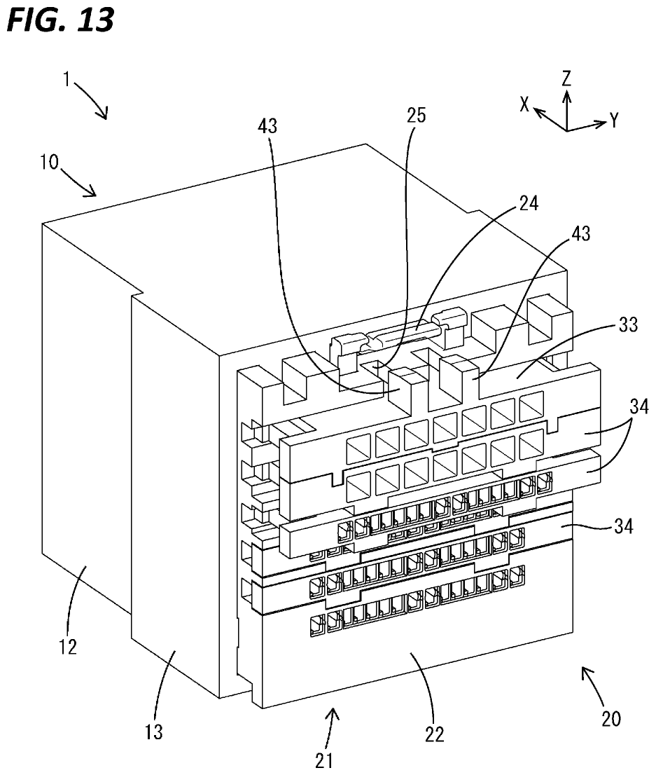

After the sub-connector 34 in the lowermost stage is moved to the connection position, the sub-connector 34 in the second stage from bottom is pushed to the connection position. Thereafter, as shown in FIG. 13, the sub-connectors 34 in the upper stages are successively moved to the connection position. Finally, the locking sub-connector 33 in the uppermost stage is pushed to the connection position. If all the sub-connectors 33, 34 are moved forward to the connection position at the same timing, friction resistance significantly increases. In that respect, in the second connector 20 of the first embodiment, the plurality of sub-connectors 33, 34 can be moved from the initial position to the connection position individually one by one, independently of the other sub-connectors 33, 34. Therefore, resistance due to the connection of the first and second terminal fittings 18, 45 can be reduced. If all the sub-connectors 33, 34 are moved to the connection position, a connecting operation of the first and second connectors 10, 20 is completed.

With the connection of the both connectors 10, 20 completed, the deflection restricting portions 43 of the locking sub-connector 33 are fit into the cut portions 25 of the holder 22 and slip under the release operating portion 24 of the lock arm 23 as shown in FIGS. 1 and 16. By arranging the deflection restricting portions 43 in the deflection allowing space 26 for the release operating portion 24, an unlocking operation of disengaging the lock arm 23 from the lock portion (not shown) cannot be performed. In this way, the both connectors 10, 20 can be reliably locked in the connected state.

In separating the first and second connectors 10, 20, the locking sub-connector 33 in the uppermost stage is moved from the connection position to the initial position as shown in FIG. 15. Subsequently, the sub-connector 34 in the second stage from top is moved from the connection position to the initial position. Thereafter, the sub-connectors 34 in the lower stages are successively moved to the initial position. Although friction resistance is generated between the tabs 19 and the resilient contact pieces (not shown) also when the sub-connector 33, 34 is moved from the connection position to the initial position, the resistance generated when the sub-connector 33, 34 is moved can be reduced since the sub-connectors 33, 34 can be moved individually one by one. After all the sub-connectors 33, 34 are moved to the initial position, the release operating portion 24 of the lock arm 23 may be pushed down to disengage the lock arm 23 from the lock portion and the both connectors 10, 20 may be pulled apart in the front-rear direction.

The connector device 1 of the first embodiment is provided with the first connector 10 including the plurality of female terminal fittings 18 and the second connector 20 connectable to the first connector 10. The second connector 20 is provided with the second housing 21 and the plurality of second terminal fittings 45. The second housing 21 includes the holder 22 and the plurality of sub-connectors 33, 34 mounted in the holder 22. A plurality of the second terminal fittings 45 are mounted in each sub-connector 33, 34. The plurality of sub-connectors 33, 34 mounted in the holder 22 can be moved individually one by one from the initial position to the connection position where the first and second terminal fittings 18, 45 are connected.

If the second connector 20 is connected to the first connector 10 with the plurality of sub-connectors 33, 34 held at the initial position in the holder 22 and the sub-connectors 33, 34 are moved forward to the connection position, the second terminal fittings 45 are connected to the female terminal fittings 18. By moving the plurality of sub-connectors 33, 34 to the connection position at different timings, a maximum value of friction resistance generated between the first and second terminal fittings 18, 45 can be reduced, wherefore workability is excellent.

The connection position is set at a position in front of the initial position. With the sub-connector 33, 34 located at the initial position, the rear ends of the moving portions 39 formed on the rear end of the sub-connector 33, 34 project further rearward than the rear end of the holder 22. According to this configuration, at which of the initial position and the connection position the sub-connector 33, 34 is located can be easily confirmed by visual observation. Further, an operation of pushing the sub-connector 33, 34 at the initial position to the connection position is easy.

With the holder 22 fit in the receptacle 13 of the first connector 10 and the sub-connectors 33, 34 located at the initial position, the first and second terminal fittings 18, 45 are held in such a positional relationship as not to be in contact with each other. According to this configuration, since friction resistance is not generated between the first and second terminal fittings 18, 45 in the process of fitting the holder 22 into the first connector 10, workability is excellent.

The sub-connector 33, 34 is formed with the resilient locking pieces 36 for restricting a movement of the sub-connector 33, 34 from the initial position to the connection position in a state where the holder 22 is not fit in the first connector 10 yet. The first connector 10 is formed with the releasing portions 16 for releasing movement restrictions by the resilient locking pieces 36 when the holder 22 is fit into the first connector 10. According to this configuration, if the holder 22 is fit into the first connector 10, the movement restrictions by the resilient locking pieces 36 are released by the releasing portions 16. Since it is not necessary to manually release the movement restrictions of the resilient locking pieces 36, workability is good.

The releasing portions 16 release the movement restrictions by resiliently deforming the resilient locking pieces 36. The first connector 10 is formed with the accommodation recesses 17 for accommodating the initial position butting portions 37 when the sub-connectors 33, 34 are moved to the connection position. The holder 22 is formed with the interference avoiding portions 30 for accommodating the initial position butting portions 37 when the sub-connectors 33, 34 are moved to the connection position. The resilient locking pieces 36 can be resiliently restored by accommodating the initial position butting portions 37 in the accommodation recesses 17 and the interference avoiding portions 30. According to this configuration, after the both connectors 10, 20 are connected, the resilient locking pieces 36 can be prevented from being left resiliently deformed.

The plurality of sub-connectors 33, 34 are mounted in the holder 22 while being stacked in the vertical direction. The sub-connector 33, 34 is formed with the stoppers 42 for locking the other sub-connector 34 in the lower stage adjacent in the stacking direction from behind. According to this configuration, if the sub-connector 33, 34 formed with the stoppers 42 is retained with respect to the holder 22, the sub-connector 34 adjacent to that sub-connector 33, 34 can also be retained.

The female terminal fitting 18 includes the tab 19 to be inserted into the second terminal fitting 45. The first connector 10 includes the connection space 14 for accommodating the tabs 19, the holder 22 being fit into the connection space 14. The first connector 10 is formed with the guide portions 15 projecting along the tabs 19. In the process of inserting the holder 22 into the connection space 14 as the both connectors 10, 20 are connected, the sub-connectors 33, 34 are guided by sliding in contact with the guide portions 15. Also in the process of moving the sub-connector 33, 34 forward from the initial position to the connection position, the sub-connector 33, 34 is guided by sliding in contact with the guide portion 15. The tabs 19 are connected to the second terminal fittings 45 without interference by guiding the sub-connector 33, 34 by the guide portion 15.

The holder 22 is formed with the lock arm 23. The lock arm 23 is resiliently deformed in the fitting process into the first connector 10. With the first and second connectors 10, 20 properly connected, the lock arm 23 resiliently returns to restrict the separation of the holder 22. The plurality of sub-connectors 33, 34 include the locking sub-connector 33 including the deflection restricting portions 43. With the holder 22 fit in the receptacle 13 of the first connector 10 and the locking sub-connector 33 pushed to the connection position, the deflection restricting portions 43 restrict the resilient deformation of the lock arm 23. According to this configuration, the deflection restricting portions 43 of the locking sub-connector 33 restrict the resilient deformation of the lock arm 23, whereby the holder 22 and the first connector 10 can be reliably held in the connected state.

### Second Embodiment

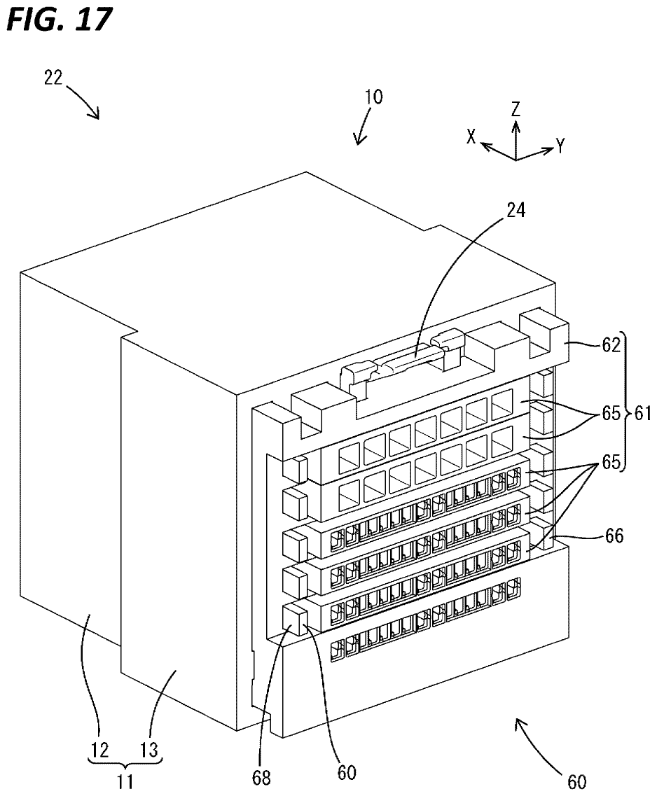

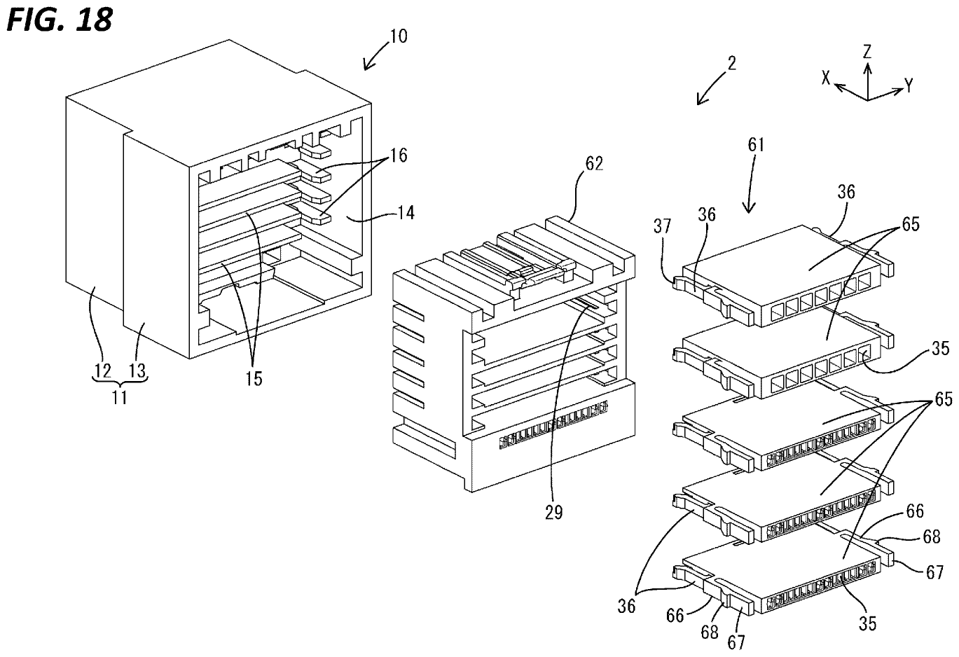

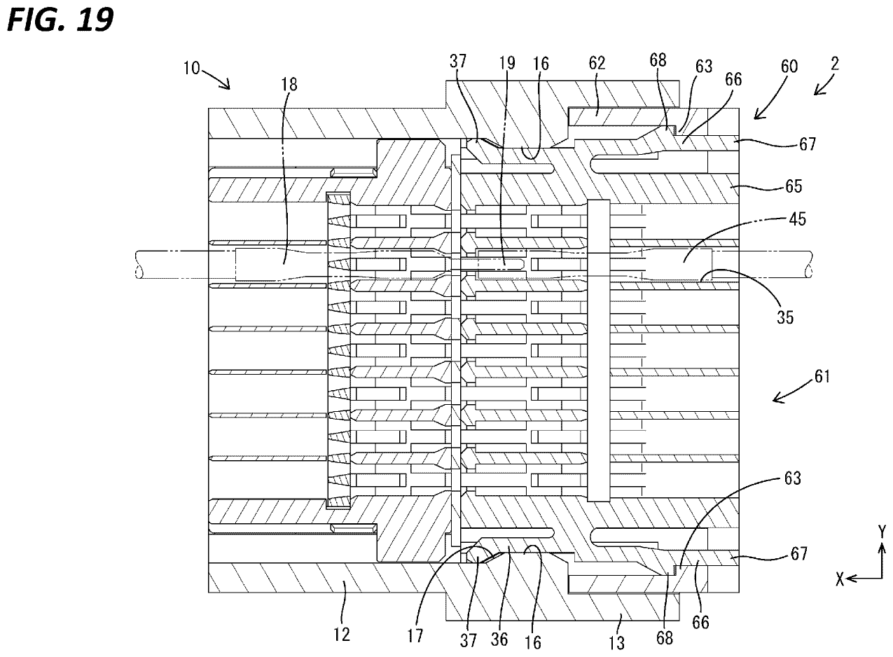

A connector device 2 of a second specific embodiment of the present disclosure is described below with reference to FIGS. 17 to 19. A positive direction of an X axis in FIGS. 17 to 19 is defined as a forward direction concerning a front-rear direction. A positive direction of a Y axis in FIGS. 17 to 19 is defined as a rightward direction concerning a lateral direction. A positive direction of a Z axis in FIGS. 17 and 18 is defined as an upward direction concerning a vertical direction.

The connector device 2 of the second embodiment differs from the first embodiment in the shapes of a holder 62 and some of a plurality of sub-connectors 65 constituting a second housing 61 of a second connector 60. In the connector device 2 of the second embodiment, the sub-connector 65 pushed to a connection position in the holder 62 can be manually returned to an initial position without using a jig. Since the other configuration is the same as in the first embodiment, the same components are denoted by the same reference signs and the structures, functions and effects thereof are not described.

A pair of resilient lock pieces 66 are formed on both left and right outer side surfaces of the sub-connector 65. The resilient lock piece 66 is cantilevered rearward and can be resiliently deformed in the lateral direction. The resilient lock piece 66 is formed with a connection position locking projection 68. A rear end part of the resilient lock piece 66 functions as a returning portion 67. The returning portion 67 is exposed on the rear end surface of the sub-connector 65.

With the sub-connector 65 moved to the connection position, the connection position locking projections 68 are locked to connection position retaining portions 63 of the holder 62 from front, whereby a movement of the sub-connector 65 toward the initial position is restricted. Since the returning portions 67 project further rearward than the rear end surface of the holder 62, the connection position locking projections 68 are disengaged from the connection position retaining portions 63 if the resilient lock pieces 66 are resiliently deformed by pinching a pair of the returning portions 67 from both left and right sides. If the sub-connector 65 is pulled rearward in this state, the sub-connector 65 at the connection position can be returned to the initial position.

### Other Embodiments

The present invention is not limited to the above described and illustrated embodiments, but is represented by claims. The present invention includes all changes in the scope of claims and in the meaning and scope of equivalents and also include the following embodiments.

With the sub-connector located at the initial position, the rear end of a connecting portion may be located at the same position as or in front of the rear end of the holder.

With the holder fit in the first connector and the sub-connectors located at the initial position, the first and second terminal fittings may be in contact with each other.

The movement restrictions of the resilient locking pieces may be manually released.

The first connector may be shaped not to include the accommodation recesses.

The sub-connector may not include the stoppers.

The first connector may be shaped not to include the guide portions.

### List of Reference Numerals

1 . . . connector device
2 . . . connector device
10 . . . first connector
11 . . . first housing
12 . . . terminal holding portion
13 . . . receptacle
14 . . . connection space
15 . . . guide portion
16 . . . releasing portion
17 . . . accommodation recess
18 . . . first terminal fitting
19 . . . tab
20 . . . second connector
21 . . . second housing
22 . . . holder
23 . . . lock arm
24 . . . release operating portion
25 . . . cut portion
26 . . . deflection allowing space
27 . . . accommodation space
28 . . . initial position front stop portion
29 . . . initial position retaining portion
30 . . . interference avoiding portion
31 . . . connection position front stop portion
32 . . . connection position retaining portion
33 . . . locking sub-connector (sub-connector)
34 . . . sub-connector
35 . . . terminal accommodation chamber
36 . . . resilient locking piece
37 . . . initial position butting portion
38 . . . initial position locking projection
39 . . . moving portion
40 . . . connection position butting portion
41 . . . connection position locking projection
42 . . . stopper
43 . . . deflection restricting portion
45 . . . second terminal fitting
46 . . . first wire
47 . . . second wire
60 . . . second connector
61 . . . second housing
62 . . . holder
63 . . . connection position retaining portion
65 . . . sub-connector
66 . . . resilient lock piece
67 . . . returning portion
68 . . . connection position locking projection

1. A connector device, comprising:
a first connector including a plurality of first terminal fittings; and
a second connector connectable to the first connector,
the second connector including a holder, a plurality of sub-connectors mounted in the holder and a plurality of second terminal fittings mounted in the sub-connectors,
the plurality of sub-connectors mounted in the holder being individually movable from an initial position to a connection position where the first terminal fittings and the second terminal fittings are connected,
the holder being formed with a lock arm configured to be resiliently deformed in the process of fitting the holder into the first connector and restrict separation of the holder by resiliently returning with the holder properly fit in the first connector,
the plurality of sub-connectors including a locking sub-connector including a deflection restricting portion, and
the deflection restricting portion being located to restrict resilient deformation of the lock arm with the holder fit in the first connector and the locking sub-connector pushed to the connection position.

2. The connector device of claim 1, wherein:
the connection position is set at a position in front of the initial position, and
a rear end of a connecting portion formed on a rear end of the sub-connector projects further rearward than a rear end of the holder with the sub-connector located at the initial position.

3. The connector device of claim 1, wherein the first terminal fittings and the second terminal fittings are held in such a positional relationship as not to be in contact with each other with the holder fit in the first connector and the sub-connectors located at the initial position.

4. The connector device of claim 1, wherein:
the sub-connector is formed with a resilient locking piece for restricting a movement of the sub-connector from the initial position to the connection position in a state where the holder is not fit in the first connector yet, and
the first connector is formed with releasing portions for releasing movement restrictions by the resilient locking pieces when the holder is fit into the first connector.

5. The connector device of claim 4, wherein:
the releasing portion releases the movement restriction by resiliently deforming the resilient locking piece, and
the first connector is formed with an accommodation recess, the resilient locking piece being accommodated into the accommodation recess to resiliently return when the sub-connector is moved to the connection position.

6. The connector device of claim 1, wherein:
the plurality of sub-connectors are mounted in a stacked state in the holder, and
the sub-connector is formed with a stopper for locking the other sub-connector adjacent in a stacking direction from behind.

7. The connector device of claim 1, wherein:
the first terminal fitting includes a tab to be inserted into the second terminal fitting,
the first connector includes a connection space for accommodating the tabs, the holder being fit into the connection space,
the first connector is formed with guide portions projecting along the tabs, and
the sub-connector is guided by sliding in contact with the guide portion in the process of moving the sub-connector from the initial position to the connection position.

8. (canceled)
